(19) United States
(12) Patent Application Publication
(10) Pub. No.: US 2010/0253318 A1
(43) Pub. Date: Oct. 7, 2010

(54) HIGH VOLTAGE TO LOW VOLTAGE INDUCTIVE POWER SUPPLY WITH CURRENT SENSOR

(76) Inventor: Kirk Thomas, SR., Escondido, CA (US)

Correspondence Address: Trevor Q. Coddington, Esq.;San Diego IP Law Group LLP, 12526 High Bluff Drive, Suite 300, San Diego, CA, 92130, US

(21) Appl. No.: 12/698,953

(22) Filed: Feb. 2, 2010

Related U.S. Application Data
(60) Provisional application No. 61/149,068, filed on Feb. 2, 2009.

(51) Int. Cl. H01F 38/28

(52) U.S. Cl. 323/358

(57) ABSTRACT

The present invention provides an inductive power supply for producing well-regulated noise-free supply of power suitable for sensitive equipment from a power transmission line. In an embodiment of the invention, the inductive power supply can be easily and safely attached to a high voltage transmission line for retrieving low voltage, AC or DC power. The inductive power supply utilizes an inductor, which is also known as a current transformer, to retrieve power from the transmission line. Energy storage components such as super capacitors may be optionally employed to store energy for later use. The electrical output of the power supply is a regulated low voltage output to power a load, e.g., sensitive electronics such as wireless devices and other microelectronics. The power supply further includes a sealed compartment for housing various types of low power devices coupled to the regulated low voltage output.

### CROSS-REFERENCE TO RELATED APPLICATION

The present application claims priority under 35 U.S.C. §119(e) to U.S. Provisional Patent Application No. 61/149,068, entitled “High Voltage to Low Voltage Inductive Power Supply with Current Sensor,” filed Feb. 2, 2009, the disclosure of which is incorporated by reference herein in its entirety.

### BACKGROUND OF THE INVENTION

1. Field of Invention

The invention relates generally to conversion of high power, high voltage alternating current energy to low voltage, low power direct current energy, and more particularly, to an economical and effective device for retrieving low power energy from bare or insulated, high power electrical conductors. In addition, the present invention relates to storing energy derived from applied power lines and to the affixing of such power converting apparatuses and methods to applied power lines that may or may not be energized when installed. In addition, the present invention relates to the measuring of the current of the applied power line for the purpose of wirelessly transmitting the measured current value to data acquisition receivers.

2. Description of Related Art

Electromagnetic induction is the production of voltage across an electrical conductor situated in a changing magnetic field or a conductor moving through a stationary magnetic field. The electromotive force (EMF) produced around a closed path is proportional to the rate of change of the magnetic flux through any surface bounded by that path. In practice, this means that an electrical current will be induced in a closed circuit when the magnetic flux through a surface bounded by the conductor changes. This applies whether the field itself changes in strength or the conductor is moved through it. Electromagnetic induction underlies the operation of power supplies, electricity generators, electric motors, transformers, induction motors, synchronous motors, solenoids, and most other electrical machines.

Electronic power supplies are used in a wide variety of industrial, commercial and consumer applications to provide stable and regulated power to many types of electronic devices. As electric current flows through a power line (alternatively referred to herein as a “cable”), it inherently produces an electromagnetic field around the cable, which can be harnessed to reproduce electricity through electromagnetic induction. By encircling an appropriately sized inductor around a section of the cable, low voltage power, proportional to the power line current, can be produced to drive low power devices. Typically, a toroidal inductor is used to retrieve the electromagnetic energy from a power line. A toroidal inductor, which is also known as a current transformer, typically comprises a circular ring-shaped magnetic core of iron powder, ferrite, or other material around which wire is coiled to make an inductor. The toroidal inductor harnesses the electromagnetic field present when current flows through an electric power line and converts it to a power signal which is then processed for low voltage direct current (DC) or alternating current (AC). Conventional inductive power supplies are described in U.S. Pat. No. 4,754,388, United States Patent Application Publication No. 2009/0230777, U.S. Pat. No. 5,425,166, and U.S. Pat. No. 5,539,300, the disclosure of which are all incorporated herein by reference in their entirety. Components of an inductive power supply include the current transformer, a voltage regulator/convertor, and input and output protection devices that protect the power supply from being damaged.

The complete range of electronic power supplies is very broad, and includes all forms of energy conversion, converting one form of electrical power to another desired form and voltage. Constraints that commonly affect power supplies include the amount of power they can supply, how long they can supply it for without needing some kind of recharging, how stable their output voltage or current is under varying load conditions, and whether they provide continuous power or pulses. Other constraints that affect power supplies are their ability to function while being exposed to a wide range of temperatures and extreme environmental conditions.

Power supplies are coupled to an energy source, to retrieve power from, and a load, where the power will be delivered. The energy source supplied to most power supplies in use today comes from an electric utility grid supplying 120 or 240 volt AC. Other sources of energy for power supplies include batteries, solar power, generators and alternators, chemical fuel cells, and electromagnetic induction.

With the advent of microelectronics and the proliferation of wireless devices, low voltage power supplies are increasingly required. There is, accordingly, a great need for a cost effective inductive power supply apparatus that harness the power of a high voltage power line and provides a well-regulated supply of power suitable for use in low power and sensitive electrical equipment.

### SUMMARY OF THE INVENTION

The present invention overcomes these and other deficiencies of the prior art by providing an inductive power supply that can be easily and safely attached to a high voltage transmission line for retrieving low voltage, AC or DC power. The inductive power supply utilizes an inductor, which is also known as a current transformer, to retrieve power from the transmission line. Energy storage components such as super capacitors may be optionally employed to store energy for later use. The electrical output of the power supply is a regulated low voltage output to power a load, e.g., sensitive electronics such as wireless devices and other microelectronics, coupled to the output of the power supply. The power supply further includes a sealed compartment for housing various types of low power devices coupled to the regulated low voltage output.

In an embodiment of the invention, a power supply comprises: a current transformer, wherein the current transformer comprises a core having a first section and a second section, the second section configured to move relative to the fixed section in order to open and close the core around a power transmission line, a clamp for securing the power supply to the power transmission line, a current sensor for measuring the current flowing through the power transmission line, an electrical output, and an enclosure to provide a protected cavity for one or more electrical components coupled to the electrical output. The core may comprise a Nickel alloy or steel. The power supply may further comprise a means for maintaining the core in a closed position around the power transmission line. The power supply may also comprise a means for correcting a non-linear output of the current sensor to a linear output. The power supply is corrosion resistant and waterproof, and is able to operate in a normal manner while being submerged in water. The power supply further comprises a means for storing electrical energy obtained from the power transmission line such as a supercapacitor. A relay is further included to switch operation of the power supply between a charging and a power supply mode. A voltage divider is further provided to set the voltage at which the relay switches between the charging and power supply modes. The power supply weighs less than two (2) pounds.

In another embodiment of the invention, a power supply comprises: a current transformer, wherein the current transformer comprises a core consisting of a first half-section and a second half-section, the second half-section configured to move relative to the fixed half-section in order to open and close the core around a power transmission line, a clamp for securing the power supply to the power transmission line, and a current sensor for measuring the current flowing through the power transmission line. The power supply may further include an enclosure to provide a protected cavity for a wireless communications transceiver. The core may comprise a Nickel alloy or steel. A plurality of potentiometers and a plurality of diodes for alternating current are provided in order to correct a non-linear output of the current sensor to a linear output. The power supply may further comprise a corrosion resistant and waterproof housing. A supercapacitor is included for storing electrical energy obtained from the power transmission line. The power supply further includes a relay for switching operation of the power supply between a charging and a power supply mode, and a voltage divider for setting a voltage at which the relay switches between the charging and power supply modes.

The present invention takes advantage of the abundant supply of electromagnetic energy present around energized power transmission lines for the purpose of powering low voltage wireless devices. The supply of power provided by the invention is easy and inexpensive to prepare and manufacture. The circuitry of the present invention minimizes variations in the voltage level produced by a DC power source. In addition, the power supply units of the present invention minimize variations in the voltage level produced by the power supply unit.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIGS. 1-5 illustrate different views of an inductive power supply apparatus according to an embodiment of the invention;

FIG. 6 illustrates the inductive power supply apparatus of FIG. 1 in an unclamped configuration for installation on an electrical power cable;

FIG. 7 illustrates the inductive power supply of FIG. 1 installed and locked onto the power transmission line according to an embodiment of the invention;

FIG. 8 illustrates a circuit diagram of an inductive power supply in the reset position according to an embodiment of the invention;

FIG. 9 lists the electrical components included in the circuit diagram of FIG. 8; and

FIG. 10 illustrates the inductive power supply of FIG. 8 in the set position.

### DETAILED DESCRIPTION OF EMBODIMENTS

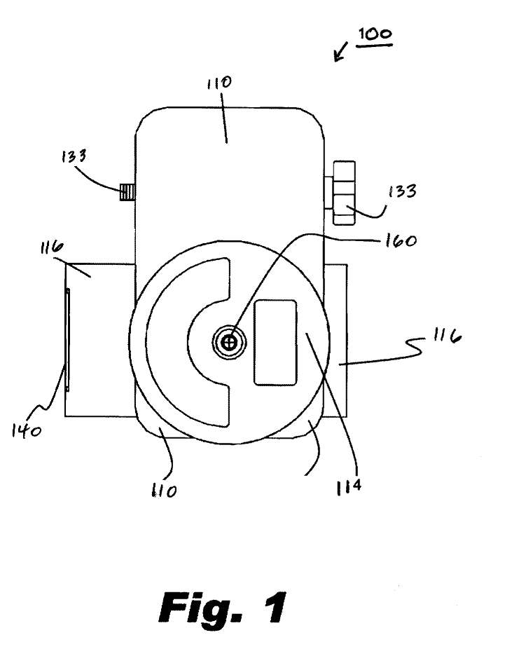

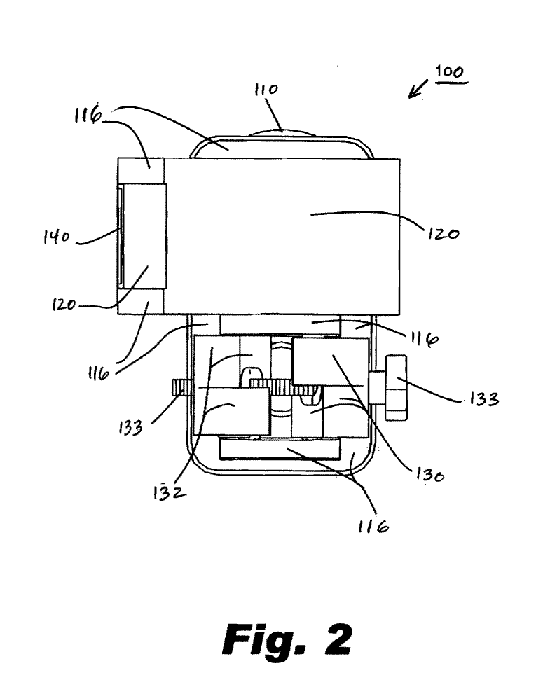

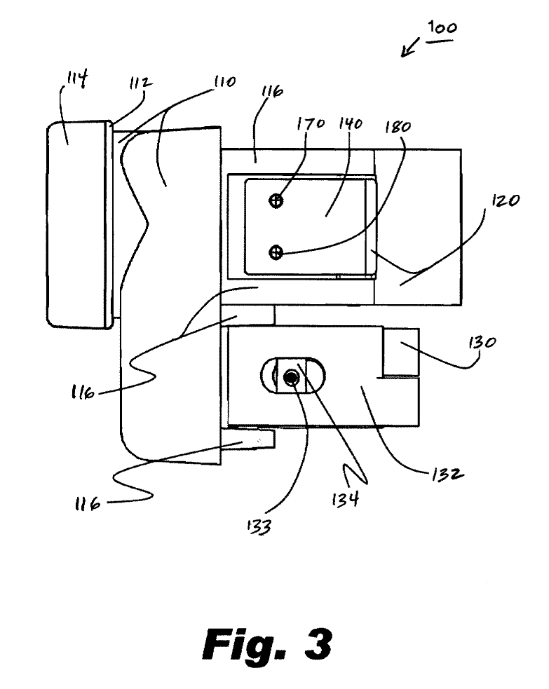

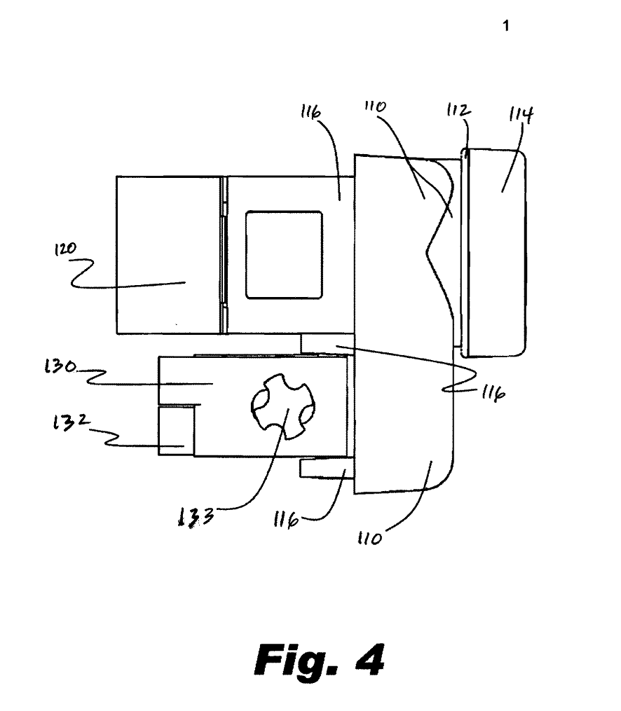

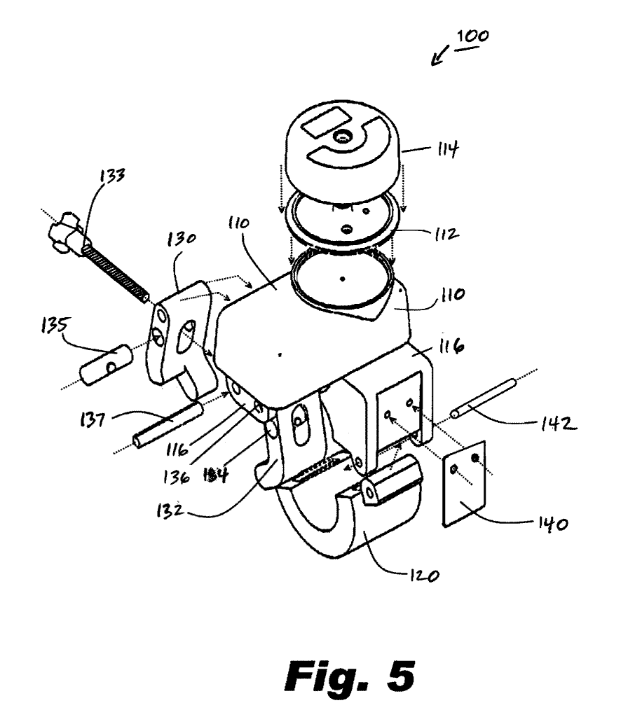

Further features and advantages of the invention, as well as the structure and operation of various embodiments of the invention, are described in detail below with reference to the accompanying FIGS. 1-10, wherein like reference numerals refer to like elements. Although the invention is described in the context of harnessing electromagnetic energy from power transmission lines associated with a public utility power grid, the invention is capable of harnessing energy from any energized electrical conductor.

Electrical power line networks supply power to virtually every corner of the world. Energized power lines inherently produce an electromagnetic field around the transmission cable, which can be harnessed to reproduce electricity in a more suitable voltage and/or current form. By placing an appropriately sized inductor around the cable, low voltage power can be produced to drive, for example, microelectronic and wireless devices. Because the quality of a communication signal improves as a wireless device is elevated from ground, harnessing the power from overhead power transmission lines becomes synergetic with the wireless world. Moreover, retrieving electrical power from an almost infinite number of access points throughout a power grid would greatly expand the use of wireless communications and surveillance devices.

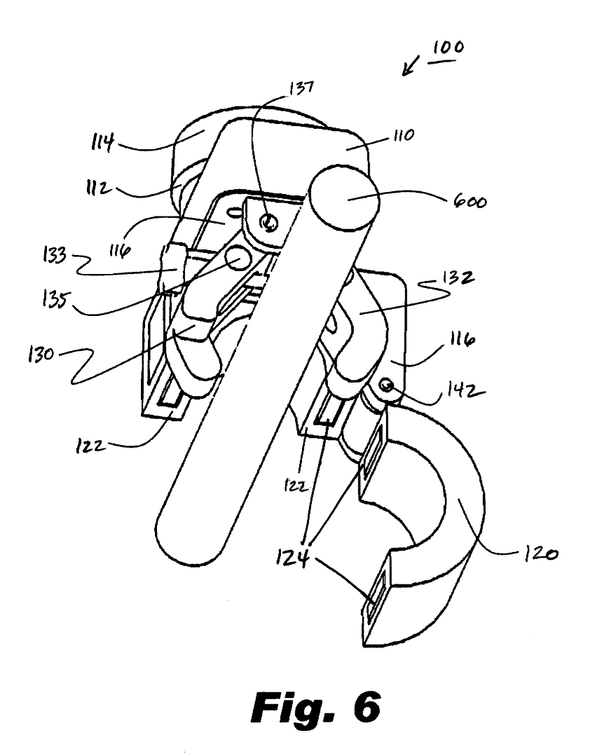

FIGS. 1-5 illustrate different views of an inductive power supply apparatus 100 according to an embodiment of the invention. FIG. 6 illustrates the inductive power supply apparatus 100 in an unclamped configuration for installation on an electrical power cable 600, which may be a bare or insulated conductor. As shown, the power supply 100 comprises a front housing 110, an enclosure adapter 112, an enclosure cover 114, a housing back cover 116, a current transformer half-round housing 120, a fixed current transformer half-round housing 122, clamping arms 130 and 132, a clamp screw 133, pivot pins 134 and 135, clamp arm pins 136 and 137, a leaf spring 140, and a core pivot pin 142.

The enclosure adapter 112 and the enclosure cover 114 provide a protected cavity to house electrical components (not shown), which are powered by the power supply 100. For example, the cavity may house a wireless communications device for transmitting data pertaining to the voltage and/or current of the electrical power cable 600 and/or operation of the power supply 100. In another example, the cavity may house electronic components such as, but not limited to surveillance equipment, lighting, indicator beacons, audible alarms, radio repeaters, wireless transceivers and WiFi access points, or any combination thereof. One of ordinary skill in the art appreciates that the electrical components and circular configuration of the enclosure adapter 112 and the enclosure cover 114 are exemplary only, and that other configurations, e.g., square or rectangular-shaped, may be implemented to house various size electrical components. As shown, an opening is provided in the enclosure adapter 112 for connecting an electrical conductor (not shown) between the electrical output (not shown) of the power supply 100 to the electrical component. In an embodiment of the invention, the enclosure adapter 112 and the enclosure cover 114 are constructed from materials, the identification of which is apparent to one of ordinary skill in the art, that shield the electrical components housed therein from interfering electromagnetic radiation.

The current transformer half-round housing 120 and the fixed current transformer half-round housing 122 make up the current transformer, i.e., inductor, of the inductive power supply apparatus 100. The current transformer half-round housing 120 is able to pivot about the core pivot pin 142. This allows the current transformer to be placed around a continuous section of the electrical power cable 600. The current transformer half-round housing 120 and the fixed current transformer half-round housing 122 each include a half-section of a circular or U-shaped ring-shaped magnetic core 124 having electrical wire (not shown) wound around such to form the inductor. In an exemplary embodiment of the invention, the magnetic core 124 comprises silica steel or electrical steel, a nickel alloy, a supermalloy, or a permalloy steel. When the current transformer is installed on the power cable 600, the current transformer half-round housing 120 and the fixed current transformer half-round housing 122 maintain contact with one another through a resistive force supplied by the leaf spring 140, thereby connecting the two half-sections of the magnetic core 124 together and closing the circuit of the electrical wire wound around the core 124.

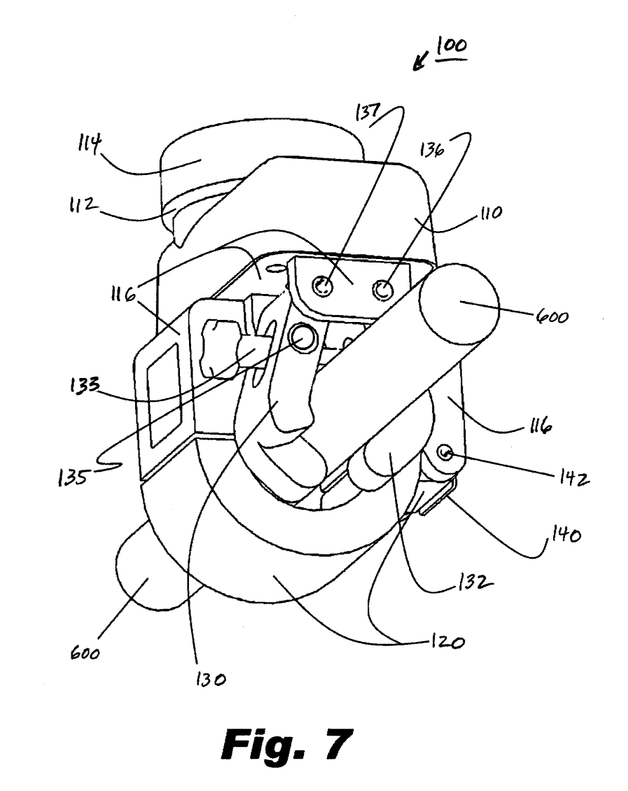

FIG. 7 illustrates the inductive power supply 100 installed and locked onto the power transmission line 600 according to an embodiment of the invention. Here, the current transformer half-round housing 120 and the fixed current transformer half-round housing 122 are in contact with one another. However, since the transformer housing components 120 and 122 are not in direct contact with the power transmission line 600, the clamping arms 130 and 132 are used to affix the power supply 100 to the power transmission line 600. The clamping arms 130 and 132 also prevent the power supply 100 from rotating about the power transmission line 600. The clamping arms 130 and 132 are further configured to maintain the axis of the power transmission line 600 aligned with the center axis of the inductor, i.e., the axis through the center of the ring-shaped enclosure, thereby optimizing the efficiency of the inductor.

In an embodiment of the invention, the inductive power supply 100 is corrosion resistant and water-proof. Exposed components are made of corrosion resistant materials. For example, exposed surfaces of the front housing 110, the enclosure cover 114, the housing back cover 116, the current transformer half-round housing 120, the fixed current transformer half-round housing 122, and the clamping arms 130 and 132 can be made of or encased in a polycarbonate material, which is corrosion resistant and stable when exposed to ultraviolet light. The clamp screw 133, the pivot pins 134 and 135, the clamp arm pins 136 and 137, the leaf spring 140, and the core pivot pin 142 may be manufactured from a corrosion-resistant material such as stainless steel or aluminum, or plated with a corrosion-resistant material such as cadmium. In an embodiment of the invention, the exposed components of the power supply 100 encase the inner electronics in a waterproof manner. In another embodiment of the invention, the inner electronics are protected from corrosion and water damage through use of a sealant impervious to water. One of ordinary skill in the art recognizes that the above-noted materials are exemplary only and other materials and various manufacturing and fabrication techniques may be used while still maintaining corrosion-resistant and water-proof characteristics. According to experiments, the power supply 100 was able to function properly for prolonged periods after being submerged in salt water.

In practice, the power supply 100 may be installed on an energized power transmission line by using two utility “hot sticks.” A hot stick is an insulated pole, usually made of fiberglass, used by electric utility workers when engaged on live-line working on energized high-voltage electric power lines while not exposing the workers to a large risk of electric shock. Various tools may be attached to the end of the hot stick. No other special tools are needed to install and lock the power supply 100 onto an energized power transmission line. In an exemplary embodiment of the invention, the power supply 100 is relatively lightweight, weighing in at under two (2) lbs, and may be easily hoisted by an average-sized worker and can be installed anywhere along the length of the power line.

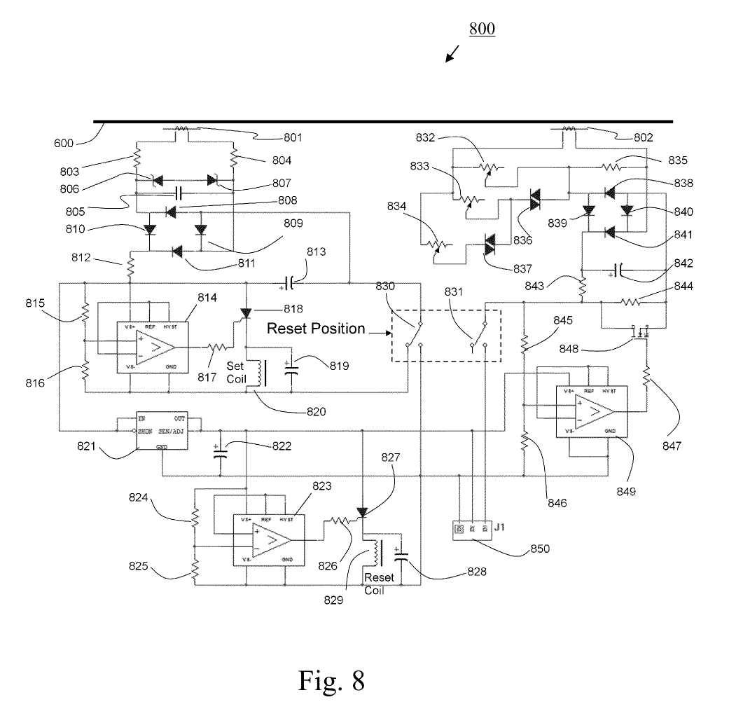

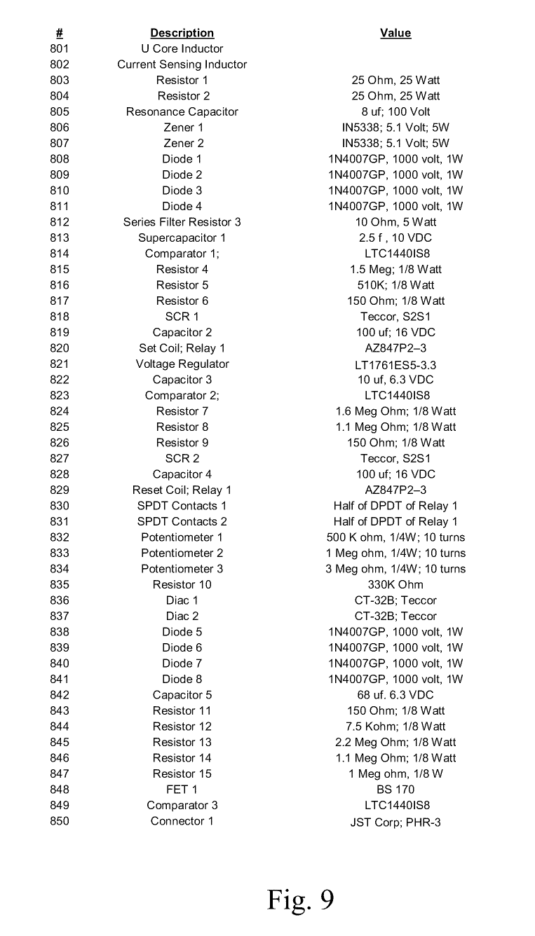

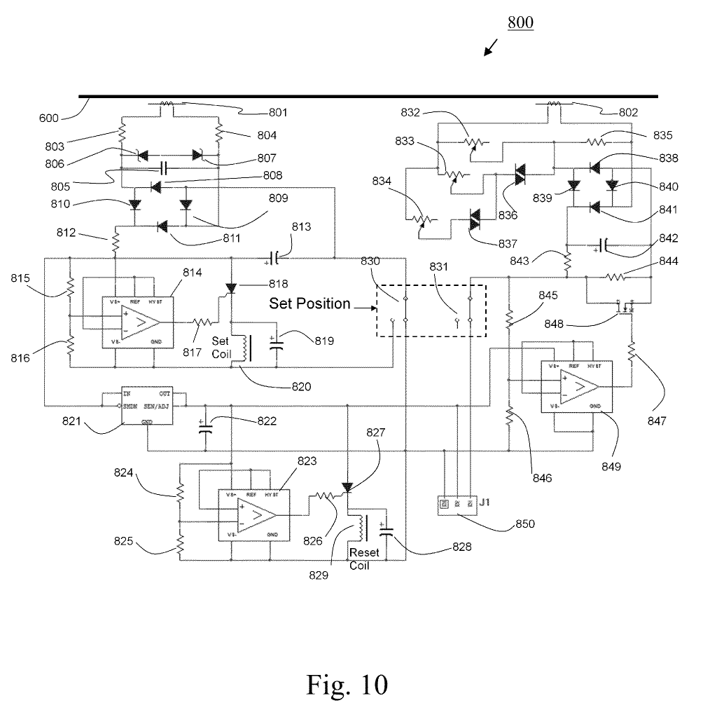

FIG. 8 illustrates a circuit diagram of an inductive power supply 800 in a “reset” position according to an embodiment of the invention. FIG. 9 lists the electrical components and exemplary details of such included in the circuit diagram of FIG. 8. FIG. 10 illustrates the inductive power supply 800 in a “set” position. Particularly, the inductive power supply 800 includes an inductor 801, which is used to power the power supply 800 from the power transmission line 600. The inductor 801 includes a coil having 350 turns and a core that is 1″ wide, 0.2″ thick, with a cross-sectional area of 0.2″ according to an exemplary embodiment.

A voltage and current limiter is coupled to the inductor 801 and comprises resistors 803 and 804 (e.g., each 25Ω at 25 W), and Zener diodes 806 and 807 (e.g., with breakdown voltages of 5.1 V at 5 W). The voltage and current limiter is coupled to a resonance capacitor 805 (e.g., 8 μF at 100 V), which resonates with the inductor 800 to produce more power at low current levels. The resonance capacitor is coupled to a power supply bridge rectifier comprised of diodes 808, 809, 810, and 811 (e.g., all of which are 1000 V at 1 W). A series filter resistor 812 (e.g., 10Ω at 5 W) is coupled to the bridge rectifier as a dropping resistor to limit current into a supercapacitor 813 (e.g., 2.5 F at 10 VDC), the implementation of which is apparent to one of ordinary skill in the art. Supercapacitors, which are also known as electric double-layer capacitors, pseudocapacitor, electrochemical double layer capacitors (EDLCs), or ultracapacitors, are electrochemical capacitors that have an unusually high energy density when compared to common capacitors, typically on the order of thousands of times greater than a high capacity electrolytic capacitor. The supercapacitor resembles a regular capacitor with the exception that it offers very high capacitance in a small package.

A voltage divider is included that comprises resistors 815 and 816 (e.g., 1.5 MΩ and 510 KΩ, respectively at 0.125 W). The output of a comparator 814 is coupled to a resistor 817 (e.g., 150Ω at 0.125 W) that limits current into a silicon-controlled rectifier (SCR) 818, which is in turn coupled to a low power capacitor 819 (e.g., 100 μF at 16 VDC) that provides extra current to the set coil 820. The set coil 820 is a polarized, bistable miniature relay comprised of dual 3V coils with double pole double throw (DPDT) contacts. The voltage divider, i.e., the resistors 815 and 816, sets the voltage at which the comparator 814 turns on. In an exemplary embodiment, the comparator 814 turns on at 4.6 volts, thereby activating the SCR 818. The set coil 820 then becomes energized and its relay contacts switch positions, thereby removing power from the set circuitry and supplying power to the regulator and the other components in order to operate in a power supply mode. In other words, when the comparator 814 turns on, it kills power to itself. The same thing is true with the comparator 823 described below.

The supercapacitor is coupled to a voltage regulator 821 of 3.3 VDC operating at 0.50 μA operating current with a 1.1 Amp low drop out (LDO) linear regulator. A capacitor 822 (e.g., 10 μF at 6.3 VDC) is coupled to the voltage regulator 821. A comparator 823 is provided that includes a voltage divider comprised of resistors 824 and 825 (e.g., 1.6 MΩ and 1.1 MΩ, respectively at 0.125 W). The comparator 823 turns on at 3 VDC and resets the device 800. It acts like the comparator 814 in that it kills power to itself, but protects any load coupled to the device 800 from voltages lower than what the load circuitry can tolerate and is only activated when the supercapacitor 813 drops below 3.1 volts due to power line 600 having no current or not enough current to keep the device 800 powered. If the load is heavy or there is a short circuit in the load, the comparator 823 would reset the device 800.

The output of the comparator 823 is connected to a resistor 826 (e.g., 150Ω at 0.125 W) to limit the current into the gate of a silicon-controlled rectifier 827, which is triggered by comparator 823 to pulse the reset coil of relay 829. A capacitor 828 (e.g., 100 μF at 16 VDC) is provided to produce extra current to pulse the reset coil of relay 829. The relay 829 is a polarized, bistable miniature relay with dual 3V coils and DPDT contacts. The relay 829 is coupled to a single pole double throw (SPDT) switch comprised of switches 830 and 831. In the reset position, the switch 830 connects ground to the set coil of relay 820 and comparator 814, and the switch 831 is open as shown. In the set position, switch 830 connects ground to the voltage regulator 821, the 3-pin connector 850, the reset coil of relay 229, and comparator 823. The switch 831 connects the current sensor to the connector 850.

A current sensor is also provided. The current sensor comprises a current sensing inductor 802, which includes a coil having 9,000 turns and a core that is 1.75″ wide, 1.0″ thick, with a cross-sectional area of 0.032″, a potentiometer 832 (e.g., 500 KΩ, 0.25 W, 10 turns), a potentiometer 833 (e.g., 1 MΩ, 0.25 W, 10 turns), a potentiometer 834 (e.g., 3 MΩ, 0.25 W, 10 turns), a resistor 835 (e.g., 330 KΩ), and two diodes for alternating current (DIAC) 836 and 837. The potentiometer 832 calibrates the output of the current sensor by adjusting the voltage divider. The potentiometer 833 corrects the non-linear output of the current sensor by changing the impedance of the potentiometer 832 at currents above 300 amps, thereby providing a linear output of the current sensor. The potentiometer 834 corrects the non-linear output of the current sensor by changing the impedance of the potentiometer 833 at currents above 600 amps, thereby providing a linear output of the current sensor. The DIAC 836 acts a variable resistor in series with the potentiometer 833. At line currents below 300 amps, the DIAC 836 is not conducting. At 300 amps, the DIAC 836 begins to conduct harder as the current increases, thus changing the voltage divider (i.e., the potentiometer 832 and the resistor 835) impedance to compensate for the non-linear nature of the current sensing inductor. The impedance of the potentiometer 833 affects how hard DIAC 836 conducts. The DIAC 837 also acts as a variable resistor in series with the potentiometer 834. At line currents below 300 amps, the DIAC 837 does not conduct current. At line currents between 300 amps and 600 amps, the DIAC 837 begins to conduct slightly. At line currents above 600 amps, the DIAC 837 conducts harder as the current increases thus changing the voltage divider impedance to compensate for the non-linear nature of the current sensing inductor 802. The impedance of the potentiometer 834 affects how hard the DIAC 837 conducts.

A current sensor bridge rectifier is coupled to the current sensor described above. The current sensor bridge comprises diodes 838, 839, 840, and 841 (e.g., 1000 V at 1 W). A capacitor 842 (e.g., 68 μF at 6.3 VDC) is provided as shown to filter the output of the current sensor bridge rectifier. Coupled to the current sensor bridge rectifier are resistors 843, 844, 845, 846, and 847, and field-effect transistor (FET) 848. The resistor 843 (e.g., 150Ω at 0.125 W) buffers the current sensor output and protects the FET 848 from capacitor discharge. The resistor 844 (e.g., 7.5 KΩ at 0.125 W) makes the output impedance compatible with most convention analog to digital converters. The resistor 845 (e.g., 2.2 MΩ at 0.125 W) and the resistor 846 (e.g., 1.1 MΩ at 0.125 W) make up part of a voltage divider for a comparator 849. The resistor 847 (e.g., 1 MΩ at 0.125 W) acts a gate resistor for the FET 848. The FET 848 shorts the resistor 844 and limits voltage output of the current sensor. The comparator 849 is an ultralow comparator and limits the current sensor output to 3.6 VDC by turning on the FET 848.

The current sensor described above enables the inductive power supply 800 to measure the current in power transmission line 600 for fault-detection and other monitoring purposes. The current sensor may be coupled to a wireless communications device powered by the inductive power supply in order to transmit data pertaining to the measured current to a remote data acquisition server, the implementation of which is apparent to one of ordinary skill in the art.

In an exemplary embodiment of the invention, a power supply has a voltage output of 5, 12, or 24 volts DC. The power supply can provide a continuous power output in the range of 6-24 watts or 12-48 watts. Alternatively, the power supply can provide a pulse power output up to 600 watts (at 12 volts DC@50 amperes) for 5 seconds. The power supply is waterproof and corrosion resistant, and is operable in the temperature range −30° C. and 70° C. Minimum power line current to operate the power supply is 5 amperes. Most over head feeder power lines carry at least 50-60 amp continuous. If low power line current is a concern, rechargeable batteries or ultra-capacitors can be employed to boost power output. Maximum line current is 800 amperes.

The present invention can be implemented in a wide variety of applications by numerous end users. For example, utility companies may utilize the present invention for wireless power quality monitoring and fault detection; an underground residential distribution (URD) motor operator, in advanced metering infrastructure (AMI) applications, which refer to systems that measure, collect and analyze energy usage, from advanced devices such as electricity meters, gas meters, and/or water meters, through various communication media on request or on a pre-defined schedule; devices implementing a ZigBee specification, which is a suite of high level communication protocols using small, low-power digital radios based on the IEEE 802.15.4-2003 standard for wireless personal area networks (WPANs); and supervisory control and data acquisition (SCADA) and faulted circuit indicator systems. Municipal governments may utilize the present invention in wireless police and fire communication repeaters; remote wireless surveillance systems; light emitted diode (LED) street lights; and public service and emergency alarms. Homeland security entities may utilize the present invention in remote wireless audio/video surveillance systems and border patrol surveillance systems. Militaries may implement the present invention in remote wireless listening and video devices, and communication repeaters. Telecommunication providers, include cellular and internet service providers, may utilize the present invention in “dead zone” low watt repeaters and other uses. Industrial complexes may utilize the present invention in wireless Ethernet Intranet/Internet routers and other equipment, power quality monitoring/control systems, and ZigBee transceivers. One of ordinary skill in the art recognizes that the above entities and applications are exemplary only, and the applications and uses of the present invention is not limited by such.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A power supply comprising:
a current transformer, wherein the current transformer comprises a core having a first section and a second section, the second section configured to move relative to the fixed section in order to open and close the core around a power transmission line,
a clamp for securing the power supply to the power transmission line,
a current sensor for measuring the current flowing through the power transmission line,
an electrical output, and
an enclosure to provide a protected cavity for one or more electrical components coupled to the electrical output.

2. The power supply of claim 1, wherein the core comprises a Nickel alloy or steel.

3. The power supply of claim 1, further comprising a means for maintaining the core in a closed position around the power transmission line.

4. The power supply of claim 1, further comprising a means for correcting a non-linear output of the current sensor to a linear output.

5. The power supply of claim 4, wherein the means for correcting comprises a plurality of potentiometers and a plurality of diodes for alternating current.

6. The power supply of claim 1, wherein the power supply is corrosion resistant and waterproof.

7. The power supply of claim 6, wherein the power supply is able to operate in a normal manner while being submerged in water.

8. The power supply of claim 1, further comprising a means for storing electrical energy obtained from the power transmission line.

9. The power supply of claim 8, wherein the means for storing electrical energy comprises a supercapacitor.

10. The power supply of claim 8, further comprising a relay for switching operation of the power supply between a charging and a power supply mode.

11. The power supply of claim 10, further comprising a voltage divider for setting a voltage at which the relay switches between the charging and power supply modes.

12. The power supply of claim 10, wherein the power supply weighs less than two (2) pounds.

13. A power supply comprising:
a current transformer, wherein the current transformer comprises a core consisting of a first half-section and a second half-section, the second half-section configured to move relative to the fixed half-section in order to open and close the core around a power transmission line,
a clamp for securing the power supply to the power transmission line, and
a current sensor for measuring the current flowing through the power transmission line.

14. The power supply of claim 13, further comprising:
an electrical output, and
an enclosure to provide a protected cavity for a wireless communications transceiver.

15. The power supply of claim 13, wherein the core comprises a Nickel alloy or steel.

16. The power supply of claim 13, further comprising a plurality of potentiometers and a plurality of diodes for alternating current in order to correct a non-linear output of the current sensor to a linear output.

17. The power supply of claim 13, further comprising a corrosion resistant and waterproof housing.

18. The power supply of claim 13, further comprising a supercapacitor for storing electrical energy obtained from the power transmission line.

19. The power supply of claim 13, further comprising a relay for switching operation of the power supply between a charging and a power supply mode.

20. The power supply of claim 19, further comprising a voltage divider for setting a voltage at which the relay switches between the charging and power supply modes.
